(19) United States
(12) Patent Application Publication
(10) Pub. No.: US 2011/0057583 A1
(43) Pub. Date: Mar. 10, 2011

(54) BATTERY-POWERED CANDLE OR LIGHTER WITH WIRELESS COMMUNICATIONS IN SUPPORT OF LIGHT-BASED "STADIUM WAVE"

(76) Inventor: Anthony Fattizzi, Point Pleasant, NJ (US)

(21) Appl. No.: 12/563,086

(22) Filed: Sep. 18, 2009

Related U.S. Application Data
(63) Continuation of application No. 12/556,248, filed on Sep. 9, 2009.

(51) Int. Cl. H05B 37/00; F21L 4/00

(52) U.S. Cl. 315/313; 362/205

(57) ABSTRACT

An electronic simulation candle comprises a housing, one or more lamps supported by the housing and having a first operative state providing a first color illumination and a second operative state providing a second color of illumination, and a manual switch connected to complete a circuit with the battery and thereby energize the one or more lamps in one of the first and second operative states. A transceiver is associated with the housing and has an antenna suitable for receiving a first code and responding to the first code by transmitting a second code. A circuit coupled to the transceiver, such as circuitry or code executing in a processor, responds to receipt of either the first code or the second code to selectively generate a gate signal. A code responsive switch is driven by the gate signal to change the first operative state to the second operative state.

This patent application is a continuation of U.S. application Ser. No. 12/556,248, filed on Sep. 9, 2009, entitled “Candle Or Lighter With LED Simulated Flame And Wireless System For Same,” which is hereby incorporated by reference in its entirety.

### TECHNICAL FIELD OF THE INVENTION

The present invention relates to an illumination product and in particular, to a candle or lighter unit that has an LED simulated flame and can easily be grasped and held by a person at an event, such as a sporting event, entertainment event, charitable event, etc.

### BACKGROUND OF THE INVENTION

The entertainment and sports industry are multi-billion dollar industries. Across the globe, hundreds of thousands of events occur yearly at a number of different venues.

At each of these events, there are a number of products that are marketed. For example, at sporting events, clothing apparel, including shirts and hats, are sold and other items such as replica equipment, including game balls, are likewise available for purchase. These items often include team logos or otherwise commemorate the event such as by including the name and date of the event. Products that support these industries generate 100's of billions of dollars yearly.

In addition, some times at commemorative events, products are given away by sponsors who view the event as an advertising opportunity. For example, it is common practice at major league baseball games (and other professional sporting events), for there to be a free giveaway night where promotional products, such as caps or bobblehead dolls, are given away. These products often times list the sponsor's name or other identifying information and serve as a means for not only sponsor advertising but also serve as a means for commemorating the event since the attendee can safe keep the item. In other words, many times, the items that are purchased or given away at events become collector items.

Many of these events occur at night or take place in arenas that can be darkened and therefore, promotional products include products that have some illuminating capability, such as glow-in-the-dark necklaces and Frisbees. It is also common at music concerts, including techno, rave and house parties and the like, for attendees to have “light sticks” or “glow sticks” that provide a safe light source and provide a vivid display. A glow stick is a single-use translucent plastic tube containing isolated substances which when combined are capable of producing light through a chemical reaction-induced chemoluminescence which does not require an electrical power source.

Over the recent years, charitable events are becoming more and more popular including charitable walks and runs. At these events, souvenir products are often marketed or are given to participants as part of the entry fee. For example, participants are often given commemorative products such as a T-shirt that memorializes the event. In addition, pens or other products can be given away that memorializes the event such as by including an inscription of the name of the event and/or the date of the event.

One of the more popular charity events in recent years is cancer related fundraising events. At these events, promotional items, such as commemorative T-shirts, are often given to the participants.

At certain events, candlelight services are conducted in order to provide a powerful symbolic unity. For example, a candlelight service of remembrance is held to celebrate the lives of loved ones who have died of a particular disease, such as breast cancer, etc. Candlelight services are often associated with events surrounding certain holidays, such as Christmas. However, candlelight services are not limited to being used as a remembrance but also they can be held as a symbol of unity amongst the participants. However, there are a number of disadvantages associated with the use of candles including foremost safety concerns. As is well known, candles are potential fire hazards and therefore, are not suitable for all individuals (e.g., children and the elderly represent potential groups that should avoid candle use).

At a number of events and settings around the globe, the lighter has become the number one symbol of approval whether it is a large concert event or a large gathering for a charitable cause. The choices for such display of approval are limited to the disposable lighter or the zippo type lighter. Both the disposable and zippo type lighters get extremely hot during extended use. In the event that an attendee forgets his or her lighter at home, a request for an encore can be less than memorable. Judging by the number of empty, unlit spaces at large events, a number of people have not come prepared. In addition, new rules and regulations concerning what items can be carried into a venue also provides an impediment to attendees who wish to request an encore or the like.

Since light can be used as a dramatic effective means for altering the appearance, it would desirable to provide a safe light based item that can be marketed to the entertainment and sports industries, etc., for purchase or to give away to attendees. It would be further desirable to provide a safe light based unit that can interact, when in the presence of other safe light units, so as to enhance the dramatic effect of a multiplicity of such units at a given event. Embodiments of the present invention can address any one or more of these needs.

### SUMMARY OF THE INVENTION

In accordance with one aspect of the invention, an electronic simulation candle comprises a housing, one or more lamps supported by the housing and having a first operative state providing a first color illumination and a second operative state providing a second color of illumination, and a manual switch connected to complete a circuit with the battery and thereby energize the one or more lamps in one of the first and second operative states. A transceiver is associated with the housing and has an antenna suitable for receiving a first code and responding to the first code by transmitting a second code. A circuit coupled to the transceiver, such as circuitry or code executing in a processor, responds to receipt of either the first code or the second code to selectively generate a gate signal. A code responsive switch is driven by the gate signal to change the first operative state to the second operative state.

In still a further aspect of the invention, an electronic simulation candle includes a housing that has a hollow interior and a lamp supported by the housing. The lamp includes one or more LEDs. The candle further includes a battery disposed within the interior of the housing and electrically connected to the lamp for providing power to the lamp. A first cover covers the lamp and is removably supported by the housing. The first cover has the shape of a flame so as to allow the electronic candle to simulate a live flame when the lamp is activated. A second cover is removably supported by the housing and is disposed above the first cover in spaced relation, wherein a weather proof seal is formed between the second cover and the housing. The candle also includes a manual switch connected to complete a circuit with the battery and thereby energize the lamp and permit a plurality of operating modes of the lamp to be selected.

In a further, optional aspect, the first and second covers have different optical characteristics and in particular, the second cover can be formed of an optical grade plastic to cause magnification of the first cover as viewed through the second cover. This enhances the overall flame simulation and operation of the candle unit. In yet a further aspect, the second cover can be formed of an optical grade plastic that is constructed to cause an increase in the scope or field of illumination of the light from the lamp that passes through the first cover.

These and other aspects, features and advantages shall be apparent from the accompanying Drawings and description of certain embodiments of the invention.

### BRIEF DESCRIPTION OF THE DRAWINGS

FIG. 1 is a perspective view of an exemplary battery operated candle unit that has a simulated flame being grasped by a participant at an event;

FIG. 2 is a perspective, partially broken away, view of the candle unit of FIG. 1 showing internal electronic components and a power source;

FIG. 3 is an exploded perspective view showing several removable inner covers for use with the candle unit of FIG. 1;

FIG. 4 is a perspective view of the candle unit of FIG. 1 with ornamental indicia formed on the outer cover to complement the inner cover;

FIG. 5 is a schematic view an exemplary battery-operated candle unit according to another embodiment of the invention in which a code responsive switch that causes the candle, when energized, to temporarily illuminate in a different color, and then revert to its primary color;

FIG. 6 is a top plan view showing a public arena in which battery-operated candles A, B, C and D are held by attendees at various locations within the arena;

FIG. 7 is a schematic diagram provided to illustrate a “stadium wave” in the public arena of FIG. 6;

FIG. 8 is a flow diagram illustrating the operation of a plurality of battery-operated candle units in one exemplary process flow in accordance with the present invention;

FIG. 9 is a chart showing transmission of codes that trigger color changes in nearby battery-operated candle units, plotted in terms of both distance and time;

FIG. 10 is a chart showing an exemplary circuit-response over time to a detection of a code at a particular battery-operated candle unit (unit A); and

FIG. 10A is a schematic diagram showing codes being transmitted in the vicinity of unit A that are being ignored by unit A′s circuitry, in accordance with a further embodiment of the invention.

### DETAILED DESCRIPTION OF CERTAIN EMBODIMENTS OF THE INVENTION

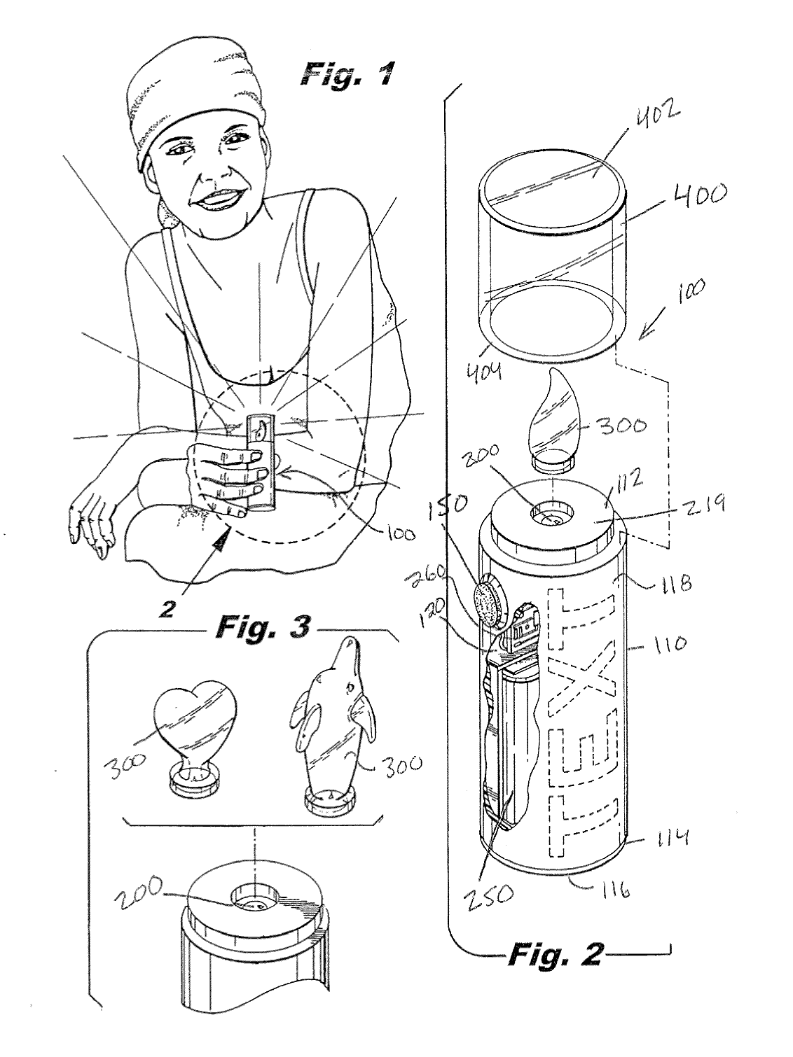

In accordance with a first embodiment of the present invention, a battery operated, hand held illumination device is shown in FIGS. 1-4. In one embodiment, the hand-held illumination device is in the form of a battery operated candle unit 100 that has a simulated flame. FIG. 1 is a perspective view of an exemplary battery operated hand held candle unit 100 that is made up of a number of different complementary parts. In particular, the candle unit 100 includes a housing 110 that has a first end 112 and an opposing second end 114. The housing 110 is a hollow structure that includes an interior compartment 120 that receives and holds various working components of the candle unit 100 as described below. The housing 110 also includes an outer surface 118.

To allow access to the interior compartment 120, a bottom wall or surface 116 of the housing 110 can be removable. For example, the bottom wall 116 can be a separate removable part of the housing 110 and it can be lockingly coupled to the remaining portion of the housing 110 using conventional coupling techniques. For example, the bottom wall 116 can include a locating tab or foot that is received into one slot formed in the housing 110 and can include a flexible locking tab that is received into another slot in the housing 110. To remove the bottom wall 116, the user simply manipulates the flexible locking tab until it disengages from its respective locking slot, thereby allowing the bottom wall 116 to be removed. Once removed, access is granted to the interior compartment 120.

It will be appreciated that the housing 110 can have any number of different shapes including but not limited to a cylindrical shape, oval shape, square shape, triangular shape, etc. It will further be appreciated that the outer surface 118 represents advertising or promotional space and therefore, the shape of the housing 110 can be selected in order to maximize the amount of advertising or promotional space. Therefore, when the housing 110 has a square shape, there are four distinct sides or surfaces that are available for the placement of advertisements and the like.

It will further be appreciated that the outer surface space 118 can also be used to document the event in that the name and date of the event can be placed on the surface. For example, if the event is a music concert, the date of the event and the name of the band along with any other identifying indicia can be provided along the outer surface 118. Conventional techniques can be used to provide this information on the outer surface 118. For example, conventional printing techniques, embossing and engraving techniques and printed adhesive backed decals can be used to provide this information of the outer surface 118 in a long lasting manner. Durability of the listed information is important since the candle unit 100 can serve as a collector's item which will be preserved and held for a period of time by the attendee or participant. The collectability aspect of the candle unit 100 is described in more detail below.

The housing 110 can be formed of any number of different materials including but not limited to plastic materials. In one embodiment, the housing 110 is formed of a “green” plastic and therefore, is more earth friendly.

The height of the entire candle unit 100 can be similar to a standard hand held lighter or it can have a greater height. For example, the height of the candle unit 100 can be between about 2.5 inches to about 8 inches.

The candle unit 100 further includes a first controllable illumination device 200. More specifically, the first illumination device 200 is in the form of a light or lamp and more particularly, the illumination device 200 can be in the form of an LED of a first color. The first light 200 is disposed along a top wall or surface 219 of the candle unit 200 so that is visible.

The first light (LED) 200 is covered with a first cover 300 (inner cover) that protects the first light 200. In accordance with one embodiment of the present invention, the first cover 300 has a flame shape so as to impart the appearance of a live flame. The first cover 300 is coupled to the top wall 219 so that it securely covers and protects the first light 200.

The first cover 300 can be attached to the top wall 219 in such a manner that it is removable therefrom to permit access to the first light 200. The first light (LED) 300 should be replaceable in the event it burns out and therefore, the removability of the first cover 300 permits such replacement.

The first cover 300 is translucent or transparent to permit the light from the first light 200 to pass therethrough and be visible. In one embodiment, the first cover 300 is formed of a clear, colorless plastic material (100% transparent); however, it will be appreciated that the first cover 300 can be formed of a colored material so long it is transparent or translucent to allow light to pass therethrough.

It will also be appreciated that the viewable color of the first light 200 can be altered by changing either the color of the LED itself or by changing the color of the first cover 300 in which case the LED can have a standard white color. LEDs come in any number of different colors, including blue and multi-colored LEDs in addition to white-light LED. In one embodiment, both the first light 200 and the first color 300 are formed of a colorless material and in this case, white light is visible.

As discussed herein, the first light 200 can also be operated in a “flicker” operating mode in which the light flickers and therefore, resembles a conventional candle.

It will readily be appreciated that the color of the first light 200 can be tailored to the particular event that the candle unit 100 is associated with. For example, some of the biggest charitable events are breast cancer awareness events and as is known across the globe, the color pink is associated with breast cancer awareness. Accordingly, the first light 200 can be customized to have a pink color, thereby making the candle unit 100 a perfect match for distribution at such events. Similarly, other events have other associated colors and the first light 200 can be tailored for such other events.

In addition, the color of the first light (LED) 200 can be matched to the main color of the outer surface of the housing 110. For example, red may be the main color associated with a particular sports team and therefore, the candle unit 100 can be constructed so that the housing 110 is red colored and the color of the “flame” (first light 200) is also red.

When the first cover 300 takes the form of a flame, the candle unit 100 simulates in appearance a working lighter and a conventional wax candle and thus has particularly utility for use in candlelight ceremonies and other events where lighters are used, such as requesting an encore at a concert as discussed above.

As shown in FIG. 2, several of the working components that are stored within the interior compartment 120 are the electronic components and power source of the candle unit 100. For example, the power source can be in the form of one or more batteries 250 (e.g., a single AA type battery or 2 AAA batteries) that are disposed within the interior compartment 120. The electronic components can include a circuit board 260 or the like that controls the operation of the candle unit 100. The power source (batteries 250) is electronically coupled to the circuit and to the first light (LED) 200.

An additional manner of providing advertising is to have a pull-tab be disposed at least partially within the interior compartment 120 between the battery and a respective contact so as to preserve the battery during initial storage and transportation. A tail portion of the pull-tab is disposed outside the interior compartment 120 and is accessible by the user. To activate the candle unit, the user simply pulls the pull-tab to remove it from is position between the battery terminal and the contact (thereby allowing electrical contact therebetween). The portion of the pull-tab that is outside of the interior compartment 120 has a surface which can be used for advertising. For example, the manufacturer of the battery can place their name and logo thereon as a means for indicating the source and brand of battery and further, be associated with the event at which the candle unit 100 is being distributed.

The housing 110 includes a switch 150 for controlling the operation of the first light (LED) 200. The switch 150 can be located in any number of different positions and can take any number of different forms. The switch 150 can be a movable switch or button that upon actuation causes the closing of the circuit and activation of the first light 200. In the illustrated embodiment, the switch 150 is located along the side of the housing 110; however, other locations are equally possible.

It will also be appreciated that in another embodiment, the candle unit 100 can also include a second light (not shown) that is located proximate the first light 200 in that it is disposed along the top wall 219. The second light is preferably an LED just as the first light 200. The second light can have the same characteristics as the first light 200 or can have different characteristics. For example, the second light can have a different color associated therewith to allow the candle unit 200 to have two colors of illumination (e.g., red and blue or two colors associated with the event).

The control unit (PCB) of the candle unit 100 can be programmed so that the first and second lights 200 can operate simultaneously or can operate alternatively or the first light 200 can operate in one operating mode (e.g., constant illumination), while the second light 210 operates in another mode (e.g., intermittent illumination). Also, as discussed above, each of the first and second lights 200 can be configured to operate in a “flicker” mode where each of the lights flickers during operation, thereby giving the appearance of a flame associated with a conventional wax candle and the like.

Both the first and second lights 200 can be housed under the same first cover 300. Alternatively, the second light can have its own second cover (not shown) similar to or different from the first cover 300. Thus, in accordance with one embodiment of the present invention, the first and second covers 300 are flame shape so as to impart the appearance of a live flame.

It will further be understood that the candle unit 100 can include more than two lights.

The candle unit 100 also includes a main cover 400 (outer cover) that is coupled to the first end 112 of the housing 110 and encloses both the first cover 300 and the first light 200. The main cover 400 includes a first enclosed end 402 and an opposite second open end 404. A lower edge (second end 404) of the main cover 400 is configured to mate with the housing 110 to allow coupling between the main cover 400 and the housing 110. For example, the first end of the housing 110 can include a locking shoulder that receives the lower edge (second end 404) to form a frictional fit, thereby coupling the main cover 400 to the housing 110. It will be appreciated that the main cover 400 can be coupled to the housing 110 using other conventional means, including but not limited to snap-fit means, etc.

In one aspect, the main cover 400 is designed to protect the first cover 300 since the pointed flame shaped first cover 300 can be more frangible/breakable in design and therefore, the outer main cover 400 acts as a protective cover. In the event that the candle unit 100 falls or other is displaced, the main cover 400 protects the first cover 300 and the lamp beneath it.

In one embodiment, the main cover 400 has different optical characteristics compared to the first cover 300. More specifically, the main cover 400 can be formed of optical grade plastic and can be constructed such that the main cover 400 acts as a magnifier. By tailoring the optical characteristics of the material of the first cover 300, the main cover 400 can be used to magnify the flickering light produced by the one or more lights 200 that are part of the candle unit 100. The result is that flame shaped cover 300 appears to be larger in size to surrounding people to give a more dramatic, more robust display of light.

In another embodiment, the main cover 400 is formed of an optical grade plastic that serves to enhance the illumination area of the light that emanates from the light 200. The main cover 400 can therefore act to scatter the light and thereby amplify the effect of the lights 200.

It will be appreciated that the main cover 400 can have other optical characteristics that in some way alter or act on the light that passes from the light 200 through the first cover 300. As a result, the main cover 400 can be formed of a different material and has different characteristics compared to the first cover 300.

In addition, the optical characteristics between the covers 300, 400 can differ in another regard in that the first cover 300, in one embodiment, is not 100% transparent or 100% clear but rather it can have some “cloudiness” to it. In other words, the first cover 300 can have a “frosted” glass look and is not completely clear. In contrast, the main cover 400 preferably is 100% clear and 100% transparent and typically is 100% colorless.

While the main cover 400 will typically have the same shape of the housing 110 to provide a uniformly shaped candle unit 100 from one end to the other, the main cover 400 can have a different shape. For example, the housing 110 can have a cylindrical shape and the main cover 400 can be heart shaped. Alternatively, the housing 110 can be square shaped and the main cover 400 can be dome shaped.

Alternatively, as shown in FIG. 3, the inner cover 300 can have a shape other than a flame shape. The shape of the inner cover 300 that surrounds the light 200 can be customized based on the event, etc. For example, at an event concerning heart disease awareness, the inner cover 300 can be heart shaped and the light 200 can be a red LED (or the inner cover 300 can be red shaped with a white or clear LED 200 underneath). It will also be appreciated that as shown in FIG. 3, the inner cover 300 is removable, as mentioned herein, and therefore, can be replaced with another inner cover 300 that has a different shape. This permits the candle unit 100 to be part of a kit that includes a number of inner covers that have different shapes, different colors, different appearance, etc., to permit the user to easily alter the appearance of the candle unit. For example, at an amusement park or the like, the inner covers 300 can take the form of a different cartoon characters or characters of different themes (e.g. a porpoise as shown). When instructed or when in a particular location of the event, the user can simply place on the appropriate inner cover 300.

The coupling of the inner cover 300 to the housing 100 can be accomplished using any number of conventional coupling techniques. For example, as shown in FIG. 3, a secure, frictional fit can be formed. Like the outer cover 400, the coupling of the inner cover 300 to the housing 110 can be weather-proof.

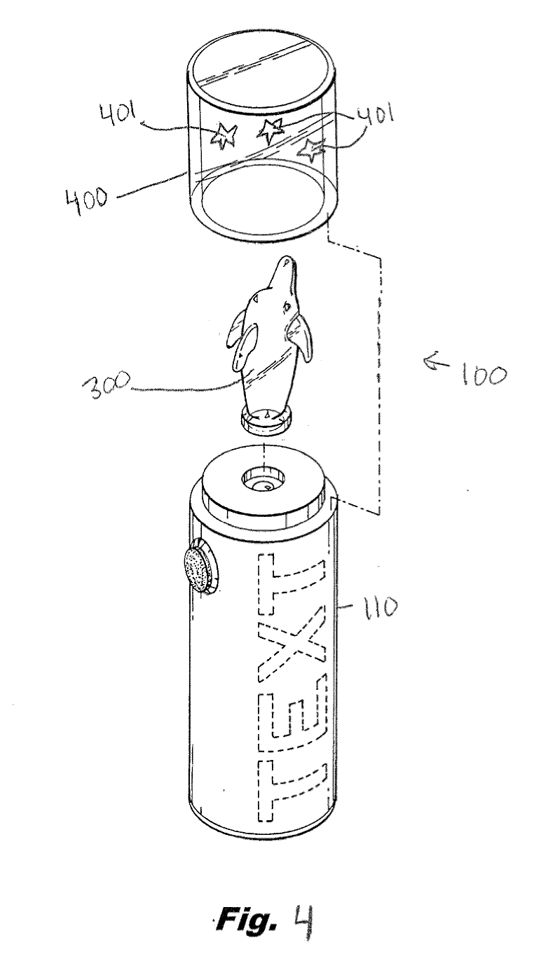

FIG. 4 illustrates another embodiment in which the outer cover 400 (main cover) can include indicia or some type of element that complements the inner cover 300. For example, if the inner cover 300 is in the form of a cartoon figure, like Tinker Bell, the outer cover 400 can include indicia 401, like stars, that complement the theme of the inner cover 300. In addition, the indicia or the like can interact with the light that is being emitted by the light (lamp) 300. For example, the stars 401 can be formed of glow-in-the-dark material or they can be formed of glitter or the like that sparkles when light shines thereon.

Since the candle unit 100 can be used in an outdoor setting (venue), a proper seal should be formed between the various components of the candle unit 100. In particular, the two covers 300, 400 of the candle unit 100 should be sealingly coupled to the other components of the candle unit 100. Thus, a seal, such as an O-ring, can be used between the bottom edge of the main cover 400 and the housing 110 to ensure that a weather proof seal is formed between the main cover 400 and the housing 110. Other types of seals can be provided and the mechanical fit between the main cover 400 and the housing 110 can be configured to provide the desired seal.

In yet another embodiment, the first cover 300 does not have a flame shape but instead, the first cover 300 has a heart shape. Such candle unit 100 is thus particularly well suited for distribution at events that are associated with caring and love or at events that fall in and around Valentine's Day.

In terms of operating modes, the switch 150 is activated to cause operation of the device and in at least one operating mode, placing the switch 150 in the “on” position results in continuous operation of the light(s) (lamps) in that the user only has to activate the switch 150 once to cause continuous operation. This is true for when the light/lamp runs in a “flicker” mode as previously discussed where the light/lamp flickers so as to emulate a real live flame. To turn the candle unit 100 to an off position, the user simply turns the switch 150 to the off position. It will be appreciated that the switch 150 can be a multi position switch in that multiple operating modes can be represented by different switch positions. For example, one operating mode can be a continuous burn operation where the light/lamp is lit continuously; one can be the flicker mode previously described and one can be an intermittent mode where the light illuminates after a predetermined amount of time that gives a different illumination appearance compared to the flicker mode.

It will therefore be appreciated that the candle unit 100 not only provides a safe alternative to a conventional live lighter or candle due to their battery-operated flame simulating characteristics but further provides an effective advertising medium that can be customized for any event and also serves as a collector's item of value. While the event name and date can be inscribed or otherwise placed on one face of the unit 100, all additional surfaces can serve as advertising space.

The marketing opportunities for the candle unit 100 are vast and include entertainment events, including concerts, festivals, holiday events; sports, including professional, amateur and the Olympics; school events, including college, high school, grammar schools, etc.; charities; political events; and other events. The candle unit 100 can be sold at the event or it can be part of a fund raising event or subject to a charitable donation or it can be given away as a free promotional as a result of revenue generated by advertising revenue.

It will further be appreciated that a number of different accessories can be provided for use with the candle unit 100. For example, a belt case can be provided for carrying the candle unit 100. The belt case can have a pocket that receives the candle unit in an upright manner and a closeable flap that can cover and protect the top of the candle unit 100. The belt case can have belt loops through which a belt can be fed for attaching the belt case to a belt.

Another accessory is in the form of a collector album that can be used to commemorate the events attended by the owner. Pages can be slotted to accept one or more candle units 100. In this manner, a page can be customized to remember and commemorate a certain event. For example, if the event is a sporting event or concert, the used ticket can be placed in another slot or the like on the page and then the candle unit 100 itself is placed into its own slot for protection and collection purposes.

In addition, a colored or otherwise commemorative jacket can be used for storing the candle unit 100. The jacket can likewise indicate the name and date of the event and serves as a protective barrier for the candle unit 100.

In addition, a carrying case can be used for storing the candle unit 100. The candle unit 100 can thus be disposed in a case that permits the candle unit 100 to be stored as a collector item. The carrying case can be formed of leather or another suitable material, such as flexible plastic, pleather, etc.

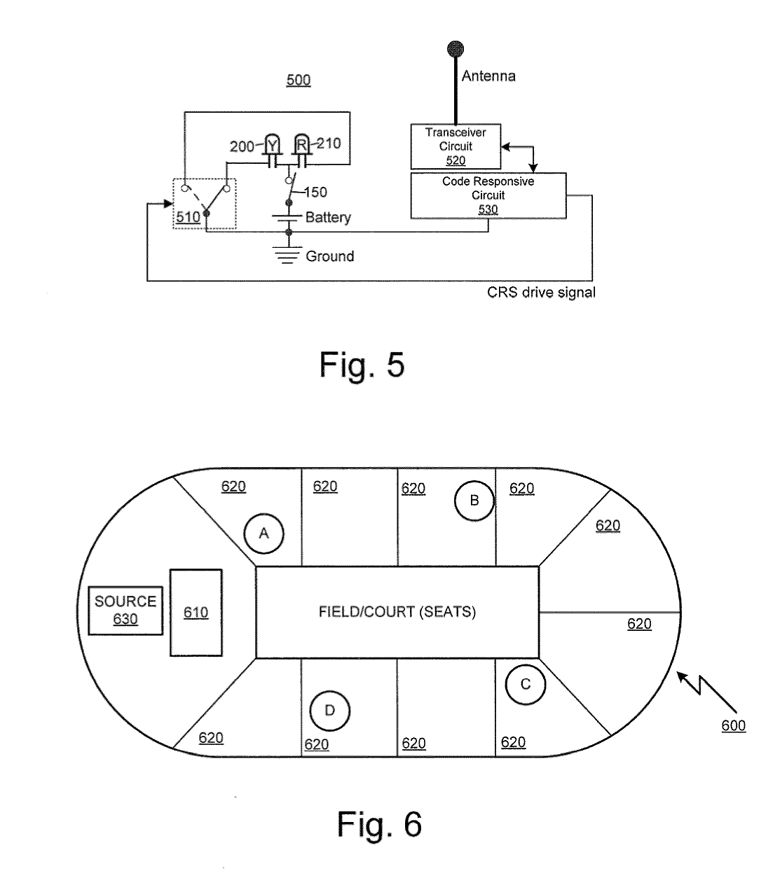

Referring now to FIG. 5, a circuit for a battery-operated, hand-held illumination device 502 according to another embodiment of the invention is shown. A hand-held illumination device including the circuit 502 can be in the form of a battery-operated lighter unit or candle unit 500 that has a simulated flame. In the circuit 502, a code responsive switch (“CRS”) 150 causes the device, when energized, to temporarily illuminate in a different color, and then revert to the primary color that it illuminates when powered on. For purposes of illustration and without limitation, the primary color can emulate a yellow flame where as the different color for temporary illumination can emulate a red flame. For instance, the LED 200 can be a yellow LED and the LED 210 can be a red LED. As understood in the art, a single multicolor LED can be energized at different voltage levels or with opposite polarities in order to provide two different colors, and in such an implementation the CRS 510 operates to apply voltages to the multicolor LED accordingly. As show in FIG. 5, one terminal of the LEDs 200, 210 is connected to the battery B, such as through the main switch 150 on the housing 110. Unlike the prior embodiments in which the second terminal of LEDs 200, 210 is connected to ground (low) potential, in this embodiment the unit 500 has the respective second terminal selectively connected through the CRS 510 to ground. The CRS can comprise a single-throw double-pole (STDP) switch and can be implemented using transistors. At any one time, the CRS completes a circuit for one of the LEDs 200 or 210 by electrically connecting the terminal to ground potential. Depending on which circuit is completed, the unit 500 shines yellow or red in this example. In the illustrated position, CRS 510 completes the circuit with the yellow LED 200. As described below, upon receipt of a recognized code, the CRS 510 responds to the code through an automated process that determines whether to temporarily switch CRS 510 to its alternate positions (shown in phantom lines) so as to complete a circuit with the red LED 210.

As can be appreciated, the first terminals of LEDs 200, 210 can be connected to ground and CRS 510 can operate to selectively complete the lamp circuits by connecting the second terminals to battery B (high) potential.

The unit 500 further includes a code receiver that supplies the code to the CRS 510. In one embodiment, the receiver is also a transmitter (i.e., it is a transceiver). Preferably, each unit 500 has a transceiver circuit 520 including for receiving and transmitting radiofrequency (RF) signals, including a beacon signal (CODE1) from a source 630 and a CODE2 signal to and from nearby units, as described further below.

The transceiver 520 can be a lower-power (e.g., 100 mw or so) transceiver that transmits and receives over one or two crystal-controlled channels via an associated antenna. For instance, transmission can be by amplitude modulation (AM) in the 27 MHz Citizens' Band or in the 49 MHz band. Such operation, at least with respect to use in the United States of America, has “permitted by part” (FCC rules Part 95) status. The transceiver 520 can be part of a single-frequency, crystal-controlled, discrete transistor circuit, and may employ a super-regenerative circuit to convert the RF signal on the antenna into an audio waveform that can be used to initiate process steps 808-822 (discussed below), including to selectively drive the CRS 510. The transceiver circuitry, in conventional manner, listens for an RF signal to be received at its antenna at a frequency established by a crystal oscillator or the like. Once a code is detected as having been received at the antenna, the transceiver 520 can switch to a transmit state (if it is operating in a half-duplex mode) or otherwise transmit the CODE2 for processing by like circuitry in other, nearby units 500.

Another option for the transceiver 520 is to transmit an RF signal in the ultra high frequency (UHF) band, such as under the family radio service (FRS) band. FRS uses channelized frequencies and as such has the capability of reduced interference effects as compared to transmissions at 27 or 49 MHz. FRS uses frequency modulation (FM) instead of AM, and so use of the FRS band requires concomitant changes to the circuitry described below for implementing the code-detection blocks 804, 806, as will be understood by persons of ordinary skill in the art.

As will be appreciated, CODE 1 can be a tone transmitted on the AM signal. CODE2 can be the same tone or a different tone transmitted on the AM signal. By having CODE1 and CODE2 as differentiable signals, the units 500 can respond to the receipt of one signal differently than to the other signal.

In an alternative implementation, the transceiver circuit 520 can comprise a radio frequency identification (“RFID”) transceiver 520 that has the capability of tag-to-tag communication. At the present time, such tags are active tags in Class IV, V or higher. The RFID tag includes an antenna that is tuned (e.g. cut to a length) to resonate in response to radio frequency signals at a wavelength that matches the antenna and its dielectric, supporting substrate. RFID tags that can be used with unit 500 can be of conventional construction. Thus, the RFID transceiver 520 is selected so as to respond to a beacon signal (code 1) from an RF source by transmitting in response to the beacon signal an alive signal (code 2). The above signal can be the same as the beacon signal in certain implementations of the invention. The RFID tag, if used, is disposed within the housing 110 and is electrically connected so as to provide a gate bias or other signal to the CRS 510. In an embodiment in which the RFID tag is a conventional tag attached to or disposed within the housing, a hall sensor or an inductive coupling 530 is disposed adjacent the tag's antenna in order to sense receipt of the beacon signal. Only the beacon signal will resonate in the antenna, and the resonance can provide a micro-signal that can be sensed, optimally amplified, and latched for a prescribed time period to the gate input of the CRS 510 in order to switch the CRS from one position to another in response to the beacon signal. In an embodiment in which the RFID circuit is integrated into the construction of the unit 500, the tag can provide the drive signal to switch the position of the CRS 510, generally as described above.

Turning now to FIG. 6, a top plan view of a public arena is illustrated. As shown, the arena is a stadium 600 having a stage 610 and a plurality of seating sections 620. Many people within the seating, sections have units 500. For purposes of discussion units 500 are held by four people and are denoted A, B, C and D. In a practical application, several thousand units 500 can be located throughout the stadium 600. Also disposed within the stadium is a source 630 that selectively outputs the beacon signal (code 1), for instance, whenever an operator presses a button, etc. to issue the RF signal. The units A, B, C and D and a multiplicity of such units 500 respond to the beacon signal or to an alive signal to produce a “wave” effect as the units change illumination from, say, yellow to red, in a sequence around the stadium.

The “wave,” also known as the “Mexican wave” or “stadium wave,” is achieved by a crowd at a stadium or other public arena when successive groups of spectators briefly stand and raise their arms. Each spectator rises at the same time as those straight in front and behind, and slightly after the person immediately to either the right (for a clockwise wave) or the left (for a counterclockwise wave). Immediately upon stretching to full height, the spectator returns to the usual seated position. The result is a “wave” of standing spectators that travels through the crowd, even though individual spectators never move away from their seats. In many large arenas the crowd is seated in a contiguous circuit all the way around the sport field, and so the wave appears to travel generally continuously around the arena.

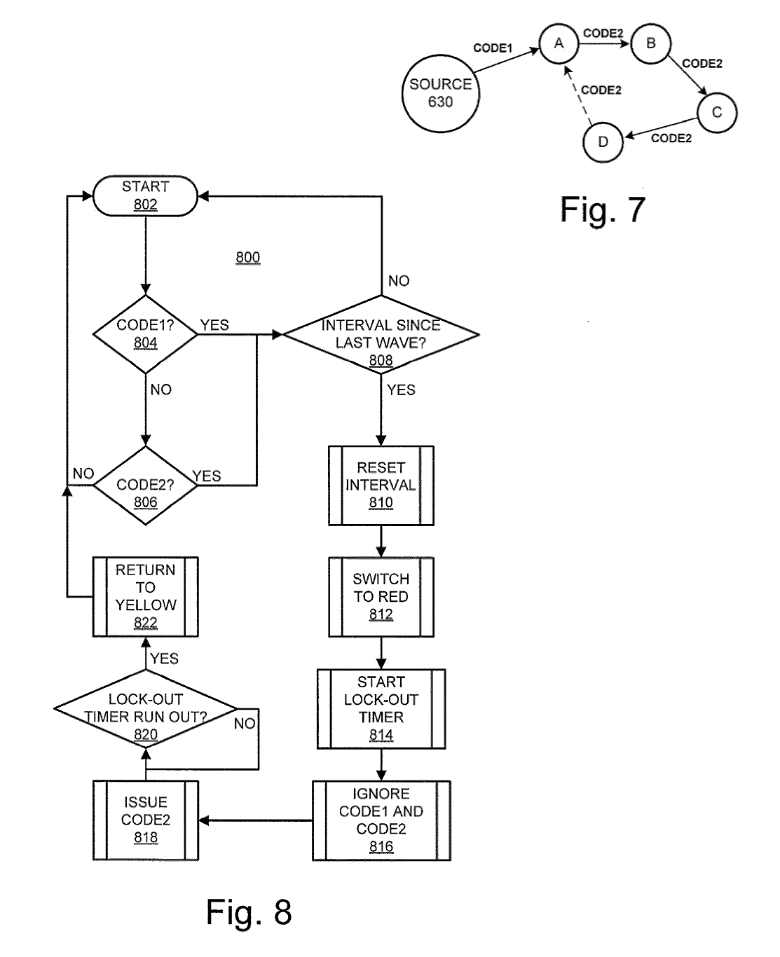

FIG. 7 is a schematic diagram provided to illustrate the “stadium wave” or “wave.” The source 630 produces a beacon signal (code 1) that is received at unit A which is closest to the source. Unit A processed the beacon signal as described further below, and in so doing generates an alive signal (code 2). The above signal is received by unit B, which is near unit A but too far from the source 630 to receive the beacon signal. Unit B processes the above signal for unit A and generates its own alive signal. This progression continues through units C and D. Unit D generates an alive signal that is received at unit A and the cycle can optionally continue again from unit A through unit D, or unit A can terminate the “wave” if it has already done the wave within a prescribed interval since the last wave.

Referring now to FIGS. 8-10, operation of a plurality of units 500 is described in connection with an example of one process flow in accordance with the present invention as a non-limiting example of a method that practices the invention.

At block 802, the method starts either for the first time or as a result of a loop back to the beginning as is hereinafter described. The process flow 800 assumes that the main switch 150 is in the “on” position such that a complete circuit is formed with at least one LED such as LED 200. At blocks 804 and 806, tests are made to determine whether either code 1 or code 2 has been detected by transceiver 520. If neither code is detected the process loops back to start 802. On the other hand of either code is detected, then a series of steps are initiated to temporarily switch the color illuminated by the particular unit 500 executing this process.

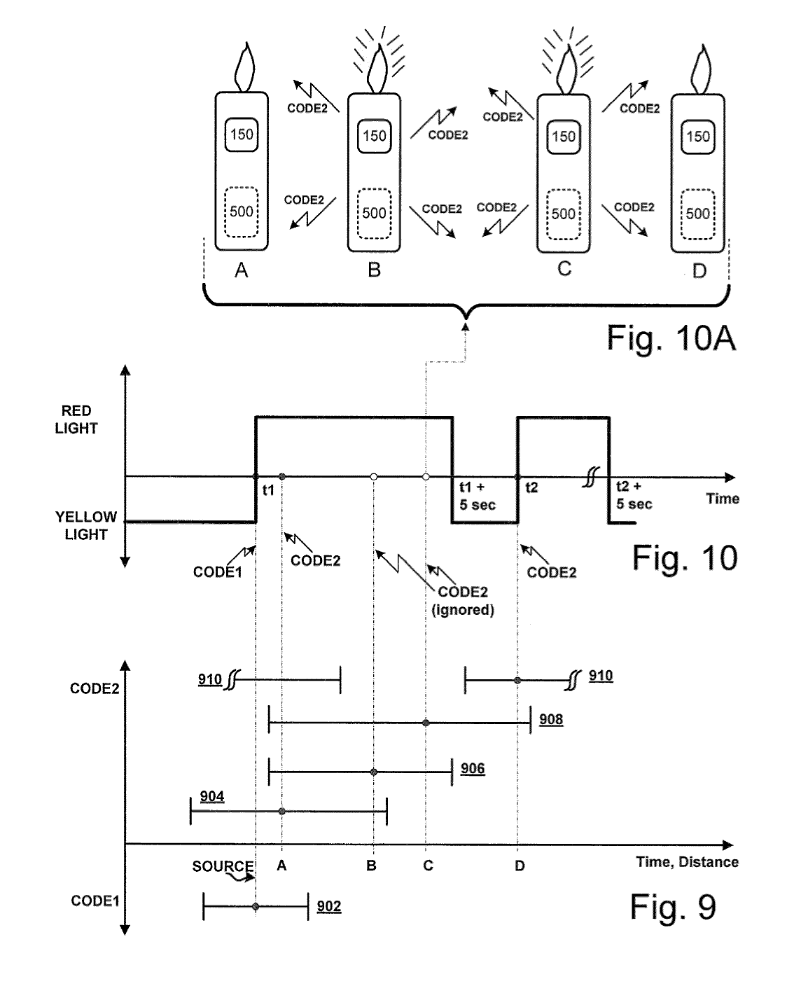

The code detection at blocks 804, 806 occur at each of the multiplicity of units 500. In FIG. 9, form units 500 are illustrated in spaced relation to one another and to the source 630 of the beacon signal (code 1). The graph in FIG. 9 illustrates several concurrent events in time, which is plotted a long the distance axis. Prior to a first time t, (see also FIG. 10), there are no detectable codes within range of the candles A-D, and the detection blocks 804, 806, determines there are no codes in the air at each of these units A-D and so the process loops back to start 802. At time t₁, the source 630 emits code 1 from its location in the stadium 600. The code 1 emits a distance as shown by the marker 902. The interval 902 spans a distance that includes the unit A, but none of units B-D.

As shown in FIG. 10, the response of unit A is illustrated on a time line that matching that of FIG. 9. Before time t₁, Unit A is powered on and illuminates a first color, such as yellow via LED 200. At time t₁, however, the code 1 is detected at Block 804. Assuming that such event has not already occurred within a prescribed interval (as tested at block 808, an potentially reset at block 810), then at block 812 the light switched to a different color, as by energizing LED 210 in red, using the CRS 510 described above. As shown in FIG. 10, the switched-light state is persisted for a set period of time. As illustrated a red-light illuminated state is maintained for 5 seconds (t₁ plus 5 seconds). After that time period, the yellow light state is resumed until such time that a further code is received (e.g., until time t₂ when code 2 is received at unit A).

With continued reference to FIGS. 8 and 9, unit A, having detected code 1 from the source 630 and switched to red at block 812, next starts a lock-out timer at block 814 that is used to immunize unit A from further codes (code 1 or code 2) for a prescribed interval such as 5 seconds. During that interval, any codes received in the vicinity of unit A are ignored, as indicated at block 816. For example, while the lock-out timer has not run out, the determining steps 804, 806 can be bypassed. Such logic can be readily implemented as code executing in a processor of the unit 500, or in logic circuitry such as can be developed and simplified using a Karnaugh Map. In addition to changing the light color and starting the lock-out tinier, unit A responds to the detected code by issuing a code, as shown at block 818. The code can be the same as the source 630 (code 1), but in this illustrated embodiment is a code 2 which is different than code 1. For example, the transceiver 520 can respond to detection of the code 1 from the source 630 or elsewhere, or to detection of code 2 another unit 500 with a code 2 being transmitted at the same frequency. Another unit B, C or D, if within range of unit A, sees code 2 and processes that code in the same way as the beacon signal is processed, and responds in kind by performing the steps at blocks 808-818.

In FIG. 9, unit A issues code 2 at time t₁ or very shortly after time t, (i.e., after the process steps respond to the beacon signal with the instruction to issue code 2). When the beacon signal is received at the transceiver 520, the unit A responds immediately to that signal with code 2. In other words, the process steps of FIG. 8 are for purposes of discussion, but a practical implementation can perform some of these functional steps in a different order than as illustrated. Thus, in FIG. 10, just after code 1 is detected at unit A, code 2 is issued from unit A (see FIG. 10). Code 2 generated by unit A spans a distance, as shown by marker 904, that includes unit B.

Just as described above, at unit B, code 2 is detected by a process 800 executing at unit B at block 806. The process executes at unit B, including block 818 which issues a code 2 from unit B that spans a distance, indicated by marker 906, which includes units A and C. In like manner, the code 2 from unit B is detected at decision block 806 of unit C to generate a further code 2, discussed next. However, the code 2 from unit B extends to the location of unit A which, at this time, already has the lock-out timer running, and which has not run out (as tested at block 820). As shown in FIG. 10, code 2 generated by unit B is received at unit A but is ignored (hollow circle).

The further code generated by unit C, spans a distance that includes units A, B and D. This wide range can occur, for instance, when unit C has strong batteries. At unit A, the code from unit C is ignored. At unit B, the code from unit C is also ignored because that unit is in the midst of its lock-out window, as previously described in regard to unit A. However, the code 2 from unit C triggers unit D, based on detection of that code at unit D by a process 800 executing thereat.

In this way, the codes are propagated from unit 500 to unit 500 around the stadium 600 or in any other venue (e.g., among persons marching in support of a charitable walk in support of curing a disease). The propagated codes cause a switching of light color in the units 500 to emulate the “wave” in public arenas, that is, to have a yellow light serially and temporarily switch to a red light at each section 620 of the stadium until the code propagation reaches the beginning again.

As illustrated in FIGS. 9 and 10, unit D has a code 2 that spans a distance 910 that includes unit A, because, in this example, units A and D are closer to each other than, say, units D and B. If by the time unit D generates code 2, such as at time t2, the timer lock-out has run out as determined at block 820, then unit A will have returned to a yellow light at block 822 (e.g., the CRS 510 is no longer latched to the LED 210) then unit A is again susceptible to changing light states in response to detection of codes received from the source 630 at block 804 or from other units such as unit D at block 806. In FIG. 9, unit A responds to code 2 from unit D.

Optionally, to prevent the wave from repeating in an indefinite manner, then interval can be established to effectively cut off the path from unit D to unit A. As shown in FIG. 7, the path is broken, and this can be accomplished by establishing a quiescent interval since the last execution of steps 812-818. If the sufficient period of time has no elapsed, as tested at block 808 with reference to a value of the interval stored in a memory cell, then the detection of codes at blocks 804, 806 is ignored by looping back to start without further processing. On the other hand, if sufficient time has passed, then the interval can be reset at block 810 (to run again for testing the next time a code is detected at that unit) and the code processing can continue as discussed previously.

Referring now to FIG. 10A, a schematic illustration shows units A, B and D at a time along the timeline when unit C is generating code 2. At this time, unit A is in the middle of its lock-up window and so unit A does not generate a code; however, unit C has been triggered by the code 2 from unit B and, as shown, and it too generates a code 2 moments after unit B is triggered to generate code 2. Meanwhile, unit D will be triggered shortly after unit C (and its lamp will illuminate in a secondary color (e.g., “red”) at block 812), while unit A will be returning to its primary color (e.g., “yellow”), at block 822. In this way, the wave is emulated by constructions of electric units 500 in accordance with the invention.

As will be understood, features and components of any of the embodiments disclosed herein can be combined in and used with other embodiments to provide the same benefits.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. An electronic illumination device having a battery to provide power to one or more lamps, comprising:
a housing sized and shaped to be held in a hand of a person;
one or more lamps supported by the housing and having a first operative state providing a first color illumination and a second operative state providing a second color of illumination;
a manual switch connected to complete a circuit with the battery and thereby energize the one or more lamps in one of the first and second operative states;
a transceiver associated with the housing and having an antenna suitable for receiving a first code and responding to the first code by transmitting a second code;
a circuit coupled to the transceiver and responsive to receipt of either the first code or the second code to selectively generate a gate signal; and
a code responsive switch driven by the gate signal to change the first operative state to the second operative state.

2. The electronic illumination device of claim 1, further comprising a lock-out timer, wherein the circuit is further configured to generate the gate signal only after the lock-out timer has run out.

3. The electronic illumination device of claim 1, further comprising a processor and wherein the circuit is code executing in the processor.

4. The electronic illumination device of claim 1, wherein the transceiver is an RFID transponder circuit.
